(19) United States
(12) Patent Application Publication
(10) Pub. No.: US 2024/0211321 A1
(43) Pub. Date: Jun. 27, 2024

(54) NETWORK DEVICES WITH USER-DEFINED MANAGEMENT OF OPERATING PARAMETERS

(71) Applicant: MELLANOX TECHNOLOGIES, LTD., Yokneam (IL)

(72) Inventors: Avraham Ganor, Shoham (IL); Yochai Cohen, Kfar Menachem (IL); Michael Weiner, Ness Ziona (IL); Yevgeny Yanovsky, Kiryat Yam (IL)

(21) Appl. No.: 18/085,858

(22) Filed: Dec. 21, 2022

(51) Int. Cl. G06F 9/50; G06F 9/445

(52) U.S. Cl. CPC G06F 9/5094; G06F 9/44505

(57) ABSTRACT

A networking device comprises one or more processing resources to perform networking functions, and one or more memory resources to store at least one user-accessible configuration file comprising a system budget that controls at least one operating parameter of the networking device. The system budget includes at least one of a power consumption limit for the networking device and a thermal limit for the networking device.

### FIELD OF THE DISCLOSURE

The present disclosure is generally directed to network devices with user-defined operating parameters.

### BACKGROUND

Servers, network switches, and other programmable resources are used in networking systems, like datacenters, for processing and routing data. Power consumption parameters and thermal requirements for resources in a datacenter may vary based on location, type of workload, and/or other factors.

### BRIEF SUMMARY

In an illustrative embodiment, a networking device comprises one or more processing resources to perform networking functions, and one or more memory resources to store at least one user-accessible configuration file comprising a system budget that controls at least one operating parameter of the networking device. The system budget includes at least one of a power consumption limit for the networking device and a thermal limit for the networking device.

In another illustrative embodiment, a DPU comprises a processor core subsystem including one or more processor cores, a network interface controller (NIC) subsystem, an interface that facilitates communication between the processor core subsystem and the NIC subsystem, and at least one memory that stores at least one user-accessible configuration file comprising a system budget that controls at least one operating parameter of the DPU. The system budget includes at least one of a power consumption limit for the DPU and a thermal limit for the DPU.

In yet another illustrative embodiment, a networking device comprises one or more memory resources to store at least one user-accessible configuration file comprising a system budget for the networking device. The system budget includes at least one of a power consumption limit for the networking device and a thermal limit for the networking device. The networking device comprises one or more processing resources to read the at least one user-accessible configuration file and to provide a user, through a user interface, with options to select at least one operating parameter of the networking device that keeps the networking device within the system budget.

It should be appreciated that inventive concepts cover any embodiment in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Additional features and advantages are described herein and will be apparent from the following description and the figures.

### BRIEF DESCRIPTION OF THE DRAWINGS

The present disclosure is described in conjunction with the appended figures, which are not necessarily drawn to scale:

FIG. 1A illustrates a block diagram of a networking system according to at least one example embodiment;

FIG. 1B illustrates a block diagram of a DPU according to at least one example embodiment;

FIG. 2 illustrates a block diagram for implementing a system budget with a user-accessible configuration file according to at least one example embodiment;

FIG. 3 illustrates a method according to at least one example embodiment; and

FIG. 4 illustrates a method according to at least one example embodiment.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, optical, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably, and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Datacenters employ a variety of networking devices to process data and route traffic. For example, a datacenter may include an array of racks with each rack including network switches (e.g., Ethernet switches), servers, data processing units (DPUs), and/or the like. In general, a DPU is a programmable processor comprising a system-on-chip (SoC) that provides high performance data processing and data transfer functions. A DPU may further include acceleration engines that offload processing tasks from other resources of the datacenter. DPU cards are becoming a heavy power consumption entity that can reach up to 150 W of power consumption per card which can be instantiated several times within a system. However, each datacenter system has its own power supply limitations and heat dissipation capabilities, which leads to each datacenter having its own budget for power consumption and/or operating temperature of networking devices in the system. Thus, the networking devices, like DPU cards, should be controlled to not exceed the given budget for the datacenter in which they are located. Given that the hardware of networking devices is generally not easily customizable and given the ever-changing requirements of workloads processed at datacenters, it has become increasingly difficult to meet power and thermal budgets for datacenters with standard approaches, which may involve using different models of networking devices in the same system. This results in a less than optimal solution for customers and can lead to a loss of design-in options because of the system design cycle and the extra work to do so.

Inventive concepts propose to solve the above listed and other shortcomings of the related art by implementing a user accessible software application programming interface (API) that enables a user to select or influence certain operating parameters of a networking device, such as the power consumption and the thermal limits of a DPU card, even after the DPU card is installed within a datacenter. In one non-limiting embodiment, the API enables a user to implement a power capping algorithm for a DPU or other networking device by, for example, allowing selection of a power consumption operating point and/or a thermal operating point from a closed list of power consumption and/or thermal operating points. Stated another way, inventive concepts relate to a user accessible interface to implement a capping algorithm that enables control of the maximum power consumption of a DPU and/or that enables control of the maximum thermal operating point of the DPU by dynamically adjusting various parameters of DPU resources. This enables the same DPU card to meet different system budgets.

At least one embodiment defines an API that enables selection of a total power consumption number for multiple DPUs. This power consumption number or limit may be programed statically into the power capping algorithm of each DPU card instantiation to limit the power consumption of each DPU card in a manner that does not exceed the desired total power consumption number to meet the system planner needs. This method of static budgeting of power consumption per each DPU card enables easy system power budget planning with high certainty and with the use of a single stock keeping unit (SKU) vs. needing multiple different SKUs in the same system.

As described herein, a user accessible API enables users to set quantitative limits on power consumption and/or operating temperature for networking devices in bulk-processing environments like datacenters in accordance with a specific system budget, where a system budge may define the maximum power consumption of a DPU or a group of DPUs and/or a maximum operating temperature of a DPU or group of DPUs. The API may be implemented to control the system budget in two modes: 1) a scriptable mode where a user selects one or more operating parameters (e.g., a specific power consumption limit and/or operating temperature limit) from of a list of operating parameters, which the DPU implements by adjusting resource usage in a predefined manner, and 2) an interactive mode where a user can influence how an operating parameter will be achieved, e.g., by instructing system to reduce a number of active cores, limit a number of accelerators, reduce clock frequency, etc.

The scriptable mode may be implemented via a command line interface for mass configuration of multiple DPU cards or for configuration of one DPU card. For example, to set a DPU to 50 W max consumption: the command may be set-power-config <device path> 50. The scriptable mode may provide command-line options to instruct the system to maximize core count, maximize clock frequency, maximize DRAM size, maximize DRAM bandwidth, and/or the like. In one embodiment, the command line interface returns value 0 for upon successful configuration of one or more DPU cards, or may return text such as: “Success; Arm cores reduced from 8 to 4; Arm clock frequency reduced from 2300 to 1500; DRAM reduced from 32 GB to 16 GB, DRAM channels reduced from 2 to 1.” By contrast, a non-limiting example of the interactive mode may allow a user to choose a target wattage and offer several combinations of resources (e.g., core count/frequency/DRAM size/DRAM bandwidth) that the user can select to satisfy that goal. Stated another way, the scriptable mode enables a user to set a system budget (e.g., a maximum power consumption and/or maximum operating temperature of a DPU or group of DPUs) and then the API automatically adjusts (e.g., throttles) certain resources of the DPU(s) to meet the selected system budget without providing selectable options for combinations of DPU resources that would meet the system budget. Notably and as stated above, the scriptable mode may enable a user to provide hints or preferences for achieving the system budget without exposing actual options for adjusting DPU resources. Meanwhile, the interactive mode enables the same selection of a system budget as the scriptable mode, but then presents the user with selectable options for combinations of DPU resources that achieve the selected system budget.

Inventive concepts may implement a selected system budget with a non-volatile configuration file stored on the DPU or in memory of a controller that controls the budget for multiple DPUs. The configuration file is user accessible through the API and is used to adjust (e.g., throttle) one or more parameters of the resources on a DPU, such as a number of Arm cores, maximum Arm clock frequency (which may affect the intermediate frequencies, e.g., the 80% and 50% frequencies), and parameters of other power consumers such as a number of double data rate (DDR) channels, a last level cache (LLC) size, a number of active solid state devices (SSDs), a number of public key accelerator (PKA) engines, reduced instruction set computer (RISC) clock frequencies, and/or the like. The configuration file may be written by the user accessible API (which may be protected by admin privileges) to offer an optimal combination of DPU resources to meet the system budget. For example, a user may use the API to set a 50 W maximum power consumption for a DPU, which in turn sets four cores of the DPU to run at 1.5 GHz with one DDR channel. In any event, the user selected configuration may be written by the API as the non-volatile configuration file (e.g., stored on the DPU in a Bfb init file) that details specific DPU operating parameters required to achieve the user selected system budget.

A networking device, such as a DPU, may follow the following steps for implementing the configuration file described herein. In some examples, the following steps may be carried out by Arm Trusted Firmware (ATF). A DPU may initially power-up with a default configuration for one or more processing and/or memory resources. The ATF may read the configuration file, as adjusted by the user through the API, from a Bfb init file to determine the power consumption limit and/or the thermal limit for the DPU (where 0 means no power consumption limit and/or no thermal limit). Thereafter, the configuration is sanitized so that the DPU cannot exceed one or more of the limits in the configuration file. If applicable, the configuration may be communicated to firmware of one or more processing resources of the DPU (e.g., firmware of a network interface controller (NIC). Then, the resources of the DPU are activated according to the configuration file (e.g., activate only the requested cores, LLCs, DRAMs, etc.). The DPU may also configure the Arm clock phase locked loops (PLLs) to requested frequencies with or without facilitation by the NIC firmware. Then, the DPU carries out the proper power/thermal capping algorithms to achieve the limitations set forth in the configuration file. Additionally, the configuration, new P-states, and/or the like are exposed to relevant monitoring interfaces (e.g., unified extensible firmware interface (UEFI), advanced configuration and power interface (ACPI), and/or the like).

As noted above, if applicable, NIC firmware may receive the configuration from the ATF, which may trigger the NIC firmware to configure certain DPU resources, such as adjustments of Arm clock PLLs to requested frequencies and/or adjustments to other components controllable by the NIC firmware.

In some examples, access to the configuration file that dynamically adjusts DPU resources is controlled and limited. For example, the API that sets the configuration file may be accessible through admin privileges (e.g., via a username and password or other secure method). In addition, the API may be aware of the SKU on which the API runs. A particular SKU may be used to identify a DPU or a group of DPUs. In this case, a SKU may have an associated system budget that the API may expose to the user. In other examples, the API queries a DPU or group of DPUs to obtain the system budget for the DPU(s).

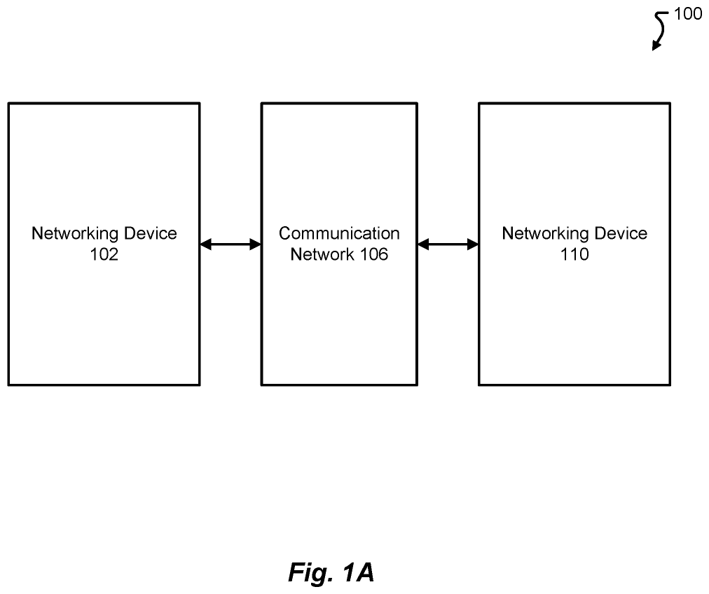

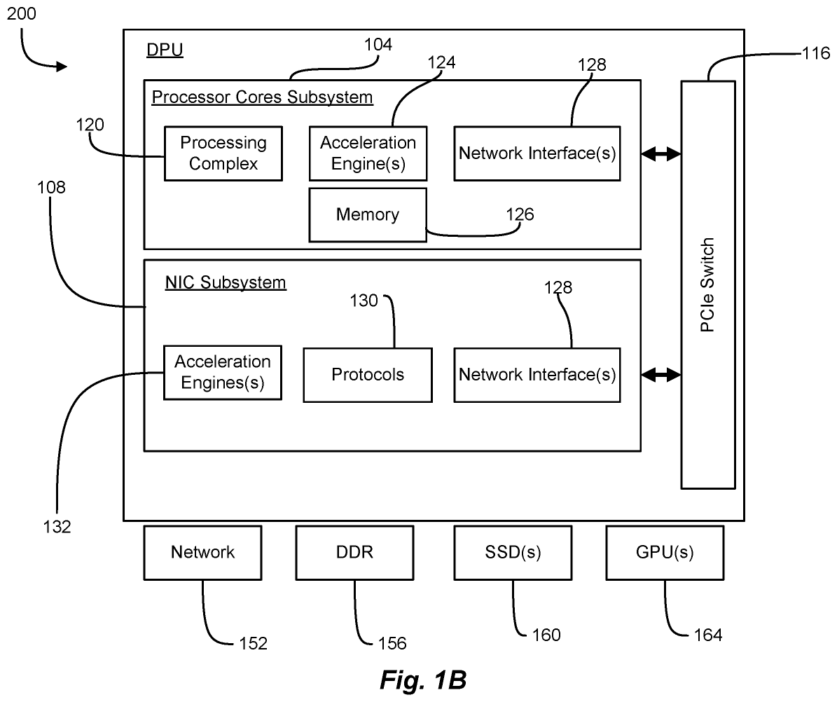

FIG. 1A illustrates a system 100 according to at least one example embodiment. The system 100 includes a networking device 102, a communication network 106, and a networking device 110. Each of the networking devices 102 and 110 may include network switches (e.g., Ethernet switches), servers, data processing units (DPUs), and/or other suitable device used for transmitting and processing data arranged within a chassis or rack. In one-non limiting embodiment, the networking devices 102 and 110 correspond to one or more DPU(s) within a datacenter. Examples of the communication network 108 that may be used to connect the networking devices 102 and 110 include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like.

Although not explicitly shown in FIG. 1A, the networking device 102 and/or the networking device 110 may include storage devices and/or processing circuits for carrying out computing tasks, for example, tasks associated with processing data and controlling the flow of data within each networking device 102 and 110 and/or over the communication network 106. Such processing circuits may comprise software, hardware, or a combination thereof. For example, the processing circuits may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuits may comprise hardware, such as an application specific integrated circuit (ASIC). Other non-limiting examples of processing circuits include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, or the like. Some or all of the processing circuits may be provided on a Printed Circuit Board (PCB) or collection of PCBs. It should be appreciated that any appropriate type of electrical component or collection of electrical components may be suitable for inclusion in the processing circuits. FIG. 1B illustrates a one specific, but non-limiting example, of a networking device 102/110 as a DPU 200.

In addition, although not explicitly shown, it should be appreciated that the networking devices 102 and 110 include one or more communication interfaces for facilitating wired and/or wireless communication over the communication network 108 between one another and other unillustrated elements of the system 100.

Referring now to FIG. 1B, a specific, non-limiting example, of a DPU 200 will be described. The DPU 200 may be implemented as an SoC. The DPU 200 is shown to provide processing capabilities that include a Network Interface Controller (“NIC”) subsystem 108 and a processor cores subsystem 104 (also called an Arm subsystem). The NIC subsystem 108 and processor cores subsystem 104 are shown to be connectable through an interface that facilitates communication between the subsystems, such as a PCIe switch 116. While the DPU 200 is shown to include a NIC subsystem 108 and processor cores subsystem 104, it should be appreciated that the DPU 200 can provide other processor functions or types including, without limitation, CPU processors, GPU processors, and/or any other suitable type of processing architecture. The NIC subsystem 108 and processor cores subsystem 104 (and, in some cases, the other illustrated elements of FIG. 1B) may be provided on a common substrate, motherboard, or silicon. Alternatively, the NIC subsystem 108 and processor cores subsystem 104 (and, in some cases, the other illustrated elements of FIG. 1B) may be provided on totally separate substrates, motherboards, or silicon.

The processor cores subsystem 104 may be configured to provide processing capabilities and may include a processing complex 120, one or more acceleration engines 124, memory 126, and one or more network interfaces 128. The processing complex 120 may include one or multiple programmable processing cores (e.g., Advanced RISC Machine (“Arm”) processing cores, RISCV cores, CPU cores, GPU cores, etc.).

The acceleration engine(s) 124 may provide hardware acceleration capabilities for the processors in the processing complex 120 and/or for external GPU(s) 164. As an example, a processing core in the processing complex 120 may use one or more acceleration engines 124 to perform a specific function whereas other undefined functions may be performed within the processing core of the processing complex 120. The acceleration engine(s) 124 can be appropriately configured to perform specified functions more quickly, with fewer computations, etc. as compared to other components of the processing complex 120.

The memory 126 may correspond to any suitable type of memory device or collection of memory devices described herein. Non-limiting examples of devices that may be provided as memory 126 include RAM, ROM, flash memory, buffer memory, combinations thereof, and the like. In some embodiments, the memory 126 stores a configuration file that is written by a user accessible API to dynamically adjust processing resources and/or memory resources of the DPU 200 in order to achieve a user-defined power consumption limit for the DPU 200 and/or a user-defined thermal limit for the DPU 200. Although the memory 126 is shown as being part of processor cores subsystem 104, the memory 126 may be included in some other part of the DPU 200 or system 100 so long as the memory 126 is accessible by the DPU 200 or other control device to implement a user-defined influenced configuration for processing and memory resources of the DPU 200.

The network interface(s) 128 may provide connectivity between components of the processor cores subsystem 104, the NIC subsystem 108, and other components. Illustratively, the network interface(s) 128 may provide connectivity to the PCIe switch 116 and/or one or more other external elements, such as external network(s) 152, DDR(s) 156, SSD(s) 160, and/or GPU(s) 164. The network interface(s) 128 may include physical, mechanical, optical, and/or electrical components that allow a remote device to communicate with the processing complex 120 and/or the NIC subsystem 108. The network interface(s) 128 may enable physical connections to a cable, wire, fiberoptic, etc. Additionally or alternatively, the network interface(s) 128 may facilitate wireless communications, in which they may include one or more antennas, drivers, or the like.

As a non-limiting example, the NIC subsystem 108 may provide functionality similar to a network adapter. Illustrated components provided in the NIC subsystem 108 include, without limitation, one or more network interfaces 128, protocols 130, and acceleration engine(s) 132. The NIC subsystem 108 may execute various protocols 130, such as transmission control protocol (TCP), user datagram protocol (UDP) protocol, remote direct memory access (RDMA) protocols, and/or the like.

The acceleration engine(s) 132 may serve the same or similar purpose for NIC subsystem 108 as do acceleration engine(s) 124 for processor cores subsystem 120. In at least one embodiment, the acceleration engine(s) 132 may comprise a Data Processing Accelerator (or Data Path Accelerator) (DPA). A DPA may include memory and one or more programmable cores including one or more hardware and/or software components that are programmable to support one or more functions of the DPU 200. Examples of a suitable programmable core include, without limitation, a programmable logic core (“PLC”), a programmable logic array (“PLA”), etc. The programmable core(s) may be implemented in hardware and/or software on any type of medium. For instance, the programmable core(s) may be provided as a programmable SoC, a programmable ASIC, a programmable digital circuit, combinations thereof, or the like. The programmable core(s) may be similar or identical to other cores described herein, such as processing cores that were described as being included in the processing complex 120.

The PCIe switch 116 may include hardware and/or software that includes an expansion bus for a PCIe hierarchy on the DPU 200. In some embodiments, the PCIe switch 116 may include switching logic that routes packets between one or more ports of the PCIe switch 116. The PCIe switch 116 may include two or more different ports that are included as or that are connected to the network interface(s) 128 of the NIC subsystem 108 and processor cores subsystem 104.

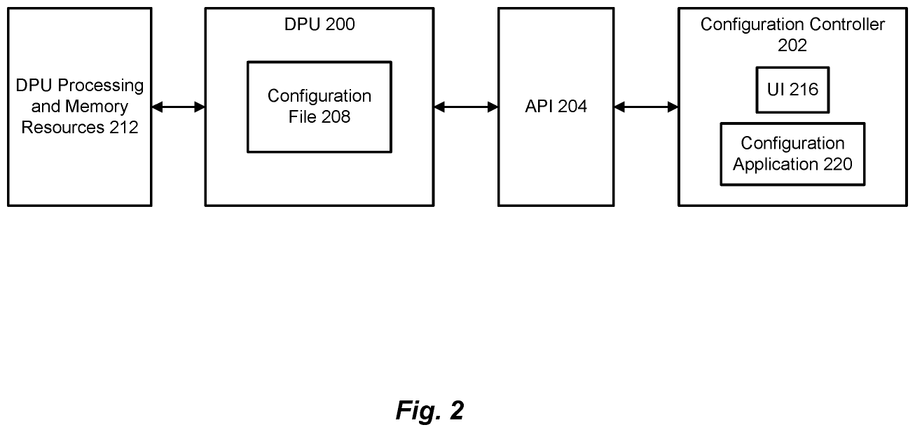

FIG. 2 illustrates a block diagram for implementing a system budget with a user-accessible configuration file used to dynamically adjust processing resources and/or memory resources of a networking device, such as a DPU 200. As shown, FIG. 2 illustrates a configuration controller 202 with a user interface (UI) 216, an API 204, a DPU 200 with a configuration file 208, and DPU processing and memory resources 212 (also referred to as resources 212). As may be appreciated, resources 212 may include memory and/or processing resources usable by a DPU 200, such as one or more of the processors, engines, and/or memories described above with reference to FIG. 1B.

The configuration controller 202 may include software and/or hardware for implementing a configuration application 220 on the UI 216 to enable a user to set quantitative values for operating points of one or more networking devices to define a system budget for the one or more networking devices. The configuration application 220 may comprise a software application running on hardware of the configuration controller 202. The UI 216 may be implemented with a suitable display and one or more user input devices (keyboard, mouse, touch screen, etc.) that enable user interaction with a command line interface or other suitable interface of the configuration application 220 that accepts user input to define operating points in the system budget. One non-limiting example of the configuration controller 202 and the UI 216 is a computing device, such as a laptop, desktop, a mobile phone, a tablet, or other computing device that enables user interaction with the configuration application 220.

Here, it should be appreciated that although various elements of FIG. 2 are illustrated as being separate from one another, one or more elements in FIG. 2 may be combined or integrated with one another. For example, the configuration controller 202, API 204, and configuration application may be implemented by and/or integrated with a DPU 200 in communication with a UI 216 to enable user interaction.

Example operating points that define a system budget for networking device, such as a DPU 200, include a power consumption limit (e.g., 100 W) for the DPU 200 and/or a thermal operating limit (e.g., 35° C.) for the DPU 200. The power consumption limit and the thermal limit may be design parameters of the system that are based on empirical data and/or user preference. In some examples, the system budget of a DPU 200 may be defined on a per-card basis so that each DPU 200 in a system 100 has its own budget. Alternatively, the same system budget may be defined for a group of DPUs 200 when, for example, the group of DPUs 200 are collocated in a same rack or chassis. In any event, the configuration file 208 stores configuration information that controls usage of resources 212 so that a DPU 200 does not exceed its power consumption limit and/or its thermal limit as defined by the budget for that DPU 200. For example, a configuration file 208 may store at least one operating parameter as configuration information for controlling one or more resources 212. The configuration file 208 may be stored at the DPU 200, such as on memory 126. Alternatively, the configuration file 208 may be stored on external memory that is accessible by the DPU 200. At least one embodiment employs multiple configuration files 208 stored on different memories. In this case, each configuration file 208 may store operating parameters that control elements of the subsystem on which that particular configuration file 208 is stored. For example, operating parameters for controlling elements of the NIC subsystem 108 may be stored in a configuration file 208 on memory of the NIC subsystem 108 while operating parameters for controlling elements of the processor cores subsystem 104 may be stored in a configuration file 208 on memory of the processor cores subsystem 104.

In some examples, the system budget of a networking device, such as the DPU 200, is implemented via configuration file 208 to control at least one operating parameter of one or more resources 212. Operating parameters of the resources 212 that are controlled by the configuration file 208 may include a number and type of active processing resources in the resources 212, a clock frequency (e.g., a max clock frequency) of one or more processing resources in the resources 212, an amount of memory usage (e.g., a max memory usage) of one or more memory resources in resources 212, operating voltage (e.g., max operating voltage) of a processing resource in one or more processing resources of the resources 212, operating voltage (e.g., max operating voltage) of a memory resource in the resources 212, operating temperature (e.g., max operating temperature) of a processing resource in the resources 212, or any combination thereof.

The API 204 may comprise software and/or hardware that facilitates communication between the configuration controller 202 and the DPU 200. For example, the API 204 may facilitate writing the configuration file 208 to one or more memory resources of the DPU 200 (e.g., memory 126) based on user input to the UI 216 that selects a power consumption limit and/or a thermal limit for the DPU 200. The API 204 may include or cooperate with Arm Trusted Firmware (ATF) of the DPU 200 and the configuration application 220 running on the configuration controller 202 to set the configuration of the DPU 200 using the configuration file 208. In at least one embodiment, user access to the configuration file 208 is controlled and limited. For example, access may be protected by administrative privileges via entry of a username and/or password on the UI 216 to authenticate that a user is allowed to make changes to the system budget, and in-turn to influence the operating parameters of resources 212 defined in the configuration file 208.

As described in more detail herein, the information included in the configuration file 208 that controls one or more operating parameters of resources 212 may be automatically selected and written by the API 204 upon user selection of a power consumption limit and/or a thermal limit for the DPU 200. Stated another way, the system may be operating in a scriptable mode that automatically sets the operating parameters of resources 212 to predefined values based on the user-selected power consumption limit and/or thermal limit for the DPU 200. For example, selecting a power consumption limit of 50 W for a DPU 200 automatically generates a configuration file that instructs the DPU 200 to operate a certain number of cores at 80% of a maximum clock frequency.

In other examples, the configuration information included in the configuration file 208 may be written by the API 204 based on some additional user input at the UI 216. For example, upon a user selecting a power consumption limit and/or a thermal limit for a DPU 200 on the UI 216, the UI 216 may present the user with a list of possible preferences to be applied to the resources 212 when implementing the power consumption limit and/or the thermal limit.

Presentation of possible preferences indicates the system is operating an interactive mode. Such user-set preferences may comprise a preference to optimize (e.g., maximize) core count of one or more processing resources in resources 212, a preference to optimize (e.g., maximize) clock frequency of one or more processing resources in resources 212, a preference to optimize (e.g., maximize) available memory capacity of one or more memory resources in resources 212, and/or a preference to optimize (e.g., maximize) bandwidth of the one or more memory resources in resources 212.

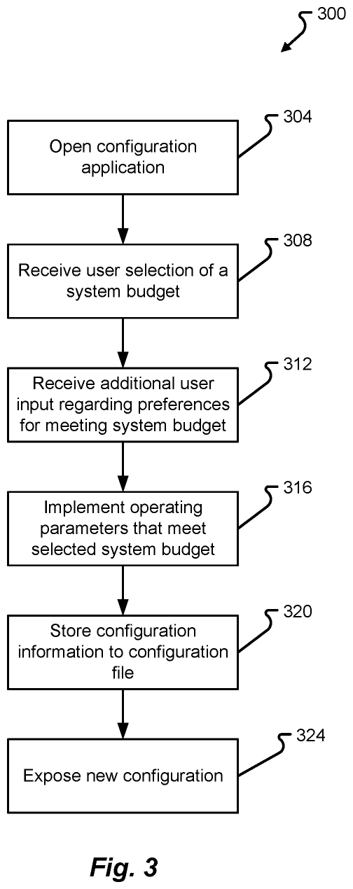

FIG. 3 illustrates a method 300 according to at least one example embodiment. The operations in FIG. 3 may be carried out by elements from FIGS. 1A to 2 described above.

Operation 304 includes opening a configuration application 220 on the UI 216 that enables a user to set a system budget for a networking device. The configuration application 220 may comprise a software application running on hardware of the configuration controller 202. In some examples, a user tasked with setting a system budget for one or more DPUs 200 provides input to the configuration controller 202 (e.g., via a mouse or keyboard) to open the configuration application 220 on a display as a command line interface or other suitable interface for accepting user input. Opening the configuration application 220 may comprise entering in administrative credentials that restrict user access to only those individuals authorized to make changes to the system budget.

Operation 308 includes receiving user selection of a system budget for a networking device or group of networking devices. For example, the configuration application 220 presented on the display may prompt the user to select certain operating parameters of a DPU 200, such as a power consumption limit and/or a thermal limit for a particular DPU 200 or a group of DPUs 200. Enabling user selection of the system budget accounts for user awareness of location-specific factors that may require limiting power consumption of DPU(s) 200 (e.g., because of location-specific power supply resources) and/or factors that may require limiting operating temperature of DPU(s) 200 (e.g., because of location-specific cooling capabilities of a system). In some cases, the configuration application 220 initially presents a default system budget with default values for power consumption and/or operating temperature to the user, which the user may then edit as part of operation 308. The configuration application 220 may also present the user with currently stored configuration information of the configuration file 208 that indicates how resources 212 are being used to achieve the default system budget.

If attempting to influence the system budget of multiple DPUs 200, a user may be presented with the option to enter a total power consumption limit for all DPUs (e.g., the power consumption of ten DPUs 200 cannot exceed 1 kW) and/or a thermal limit that should not be exceeded at each DPU 200 (e.g., each DPU 200 must keep its operating temperature below 40° C.). User input to the configuration application 220 may include manual entry of quantitative values for power consumption and operating temperature and/or selection of quantitative values from a respective predefined lists of possible power consumption and temperature values.

Here, it should be appreciated that the configuration application 220 is operable in the different modes described herein—1) the scriptable mode where a user selects one or more operating parameters of a DPU 200 (e.g., a specific power consumption limit and/or operating temperature limit) from of a list of operating parameters, which the DPU 200 implements by automatically adjusting usage of resources 212 a predefined manner, and 2) the interactive mode where a user can influence how an operating parameter will be achieved, e.g., by instructing system to optimize a number of active cores, optimize a number of accelerators, optimize clock frequency, etc. If operating in the scriptable mode, the method 300 may proceed from operation 308 directly to operation 316, where the resources 212 are automatically configured to achieve the system budget selected in operation 312. If operating in the interactive mode, however, operation 308 may be followed by operation 312. Notably, the user may be presented with the option to operate in either the scriptable or the interactive mode upon opening the configuration application 220 in operation 304. In other examples, the mode is preset and not selectable.

Operation 312 includes receiving additional user input regarding preferences for meeting the system budget selected in operation 308. Such user-set preferences may comprise a preference to optimize (e.g., maximize) core count of one or more processing resources in resources 212, a preference to optimize (e.g., maximize) clock frequency of one or more processing resources in resources 212, a preference to optimize (e.g., maximize) available memory capacity of one or more memory resources in resources 212, and/or a preference to optimize (e.g., maximize) bandwidth of the one or more memory resources in resources 212. Each preference may be selected individually by the user on the UI 216 or the UI 216 may present the user with options to select from different groups of preferences. For example, selecting a power consumption limit of 50 W for a DPU 200 may cause the UI 216 to generate and present different groupings of preferences that keep the power consumption under 50 W (e.g., selection between a group of preferences to optimize memory capacity and clock frequency, a group of preferences to optimize core count and memory capacity, or a group of preferences to optimize memory capacity and bandwidth).

Operation 316 includes implementing operating parameters of the resources 212 as dictated by the system budget selected in operation 308 and the mode in which the system is operating (i.e., the scriptable mode or the interactive mode). For example, the DPU 200 activates selected processing cores, adjusts clock frequencies, dedicates memory, and generally takes suitable actions that ensure the DPU 200 operates resources 212 in a manner that does not exceed the power consumption limit and/or the thermal limit of the DPU 200 as defined by the user-selected system budget in operations 308 and/or 312.

Operation 320 includes storing the operating parameters of the resources 212 as configuration information in the configuration file 208. The configuration file 208 may be stored as an init file. Operation 320 may occur in conjunction with operation 316. The configuration file 208 may comprise or be presented to a user in a data structure, such as a table, that associates operating parameters with values thereof. For example, the table may include columns of operating parameters for resources 212 associated to values for each operating parameter. For example, the table may be formatted in a manner that facilitates user readability to indicate that a number of active processing cores is equal to four, a number of DDR channels as being equal to two, and so on for other operating parameters listed herein. In some examples, the method provides feedback to confirm successful configuration of the networking device according to the configuration file. For example, the table indicating the operating parameters for resources 312 may be presented to the user on the UI 216 in operation 316 and/or 320 so that the user can confirm or disconfirm that the operating parameters have been set properly. Additionally or alternatively, the table may be presented to the user on the UI 216 in another iteration of the method 300 (e.g., in operation 304) that aims to update the system budget through the configuration application 220. In some examples, the configuration information is stored in multiple configuration files 208 scattered across multiple distinct memories. For example, operating parameters for elements of the NIC subsystem 108 may be stored in a configuration file 208 on memory of the NIC subsystem 108 while operating parameters for elements the processor cores subsystem 104 may be stored in a configuration file 208 on memory of the processor cores subsystem 104.

Operation 324 includes exposing (by the API 204) the newly configured parameters to other elements of the system 100. For example, operation 324 exposes the configuration information in the configuration file 208 to one or more interfaces of the DPU 200, such as an ACPI or UEFI.

After execution of the method 300, a DPU 200 is ready to operate resources 312 as dictated by the configuration information in the configuration file 208 to ensure that the DPU 200 does not exceed the operating points defined by the system budget. In the event that the system budget contains multiple operating points to be met or not exceeded, the operating parameters of the resources 212 may be controlled so as to meet or not exceed only one of the operating points (e.g., a priority operating point). For example, if the system budget defines a maximum power consumption of 100 W and a maximum operating temperature of 40° C., but operating the DPU 200 at 90 W would cause the maximum operating temperature to be exceeded, then the resources 212 may be controlled to ensure compliance with only the maximum operating temperature. Notably, the user may select which operating point in the system budget should take priority when defining the system budget in operation 308.

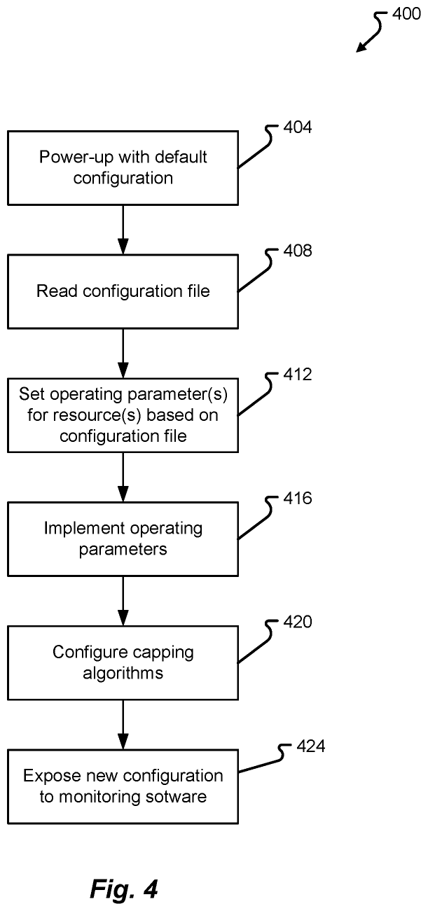

FIG. 4 illustrates a method 400 for implementing configuration information in a networking device according to at least one example embodiment. The method 400 may be carried out by various elements described herein, and in some examples, involves Arm Trusted Firmware of a DPU 200.

Operation 404 includes powering up a networking device, such as a DPU 200, with a default configuration for operating resources 212 of the DPU 200 according to a default system budget.

In operation 408, the trusted firmware of the DPU 200 may read the configuration file 208 to see if an existing user-set configuration exists for resources 212 of the DPU 200. If the configuration file 208 does not exist, contains incomplete configuration information, or the read attempt returns a null value, the method 400 may send a notification or prompt (e.g., via UI 216) to notify a user that a system budget could be selected according to the method 300. In some examples, a failed read of the configuration file 208 automatically opens the configuration application 220 on the UI 216 as a prompt for the user to set the system budget. If operation 408 successfully retrieves the configuration file 208, the method 400 proceeds to operation 412 to set the operating parameters of resources 212 to the values indicated by the configuration information in the configuration file 208.

Operation 416 includes implementing the set operating parameters at the resources 212, which may include activation and/or deactivation of certain resources 212, voltage supply adjustments for operating resources 212, and/or other adjustments to the resources 212 described herein.

Operation 420 includes configuring capping algorithms using the implemented operating parameters. For example, a DPU 200 may exist within a system of many DPUs 200, at least some of which are centrally controlled by one or more capping algorithms that are executed to distribute workloads to the DPUs 200 to optimize system performance while ensuring that the system budget for each DPU 200 is achieved.

Operation 424 includes exposing the new configuration of the DPU(s) 200 to other elements of the system, such as a ACPI, a UEFI, and/or the like.

Here, it should be appreciated that to the extent one or more of the operating parameters of resources 212 should be communicated by the firmware of the DPU 200 to one or more other elements of the DPU 200 (e.g., to the NIC subsystem 108), the method 400 does so at an appropriate time (e.g., as part of operation 412).

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

It should be appreciated that inventive concepts cover any embodiment in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Example embodiments may be configured as follows:
(1) A networking device, comprising:
   one or more processing resources to perform networking functions; and
   one or more memory resources to store at least one user-accessible configuration file comprising a system budget that controls at least one operating parameter of the networking device, wherein the system budget includes at least one of a power consumption limit for the networking device and a thermal limit for the networking device.
(2) The networking device of (1), wherein the one or more processing resources comprise resources of a data processing unit (DPU).
(3) The networking device of one or more of (1) to (2), wherein the at least one operating parameter comprises a number of active processing resources in the one or more processing resources, a clock frequency of the one or more processing resources, an amount of memory usage of the one or more memory resources, operating voltage of a processing resource in the one or more processing resources, operating voltage of a memory resource in the one or more memory resources, operating temperature of a processing resource in the one or more processing resources, or any combination thereof.
(4) The networking device of one or more of (1) to (3), further comprising:
   an interface that facilitates communication, wherein the one or more processing resources comprises a processor core subsystem and a network interface controller (NIC) subsystem coupled to one another through the interface.
(5) The networking device of one or more of (1) to (4), wherein, upon power-up of the networking device, the one or more processing resources:
   reads the at least one user-accessible configuration file from the one or more memory resources; and
   sets, based on user input received through a user interface, the at least one operating parameter.
(6) The networking device of one or more of (1) to (5), wherein access to the at least one user-accessible configuration file is controlled and limited.
(7) The networking device of one or more of (1) to (6), wherein the at least one operating parameter is selected to avoid exceeding either the power consumption limit or the thermal limit.
(8) The networking device of one or more of (1) to (7), wherein the at least one user-accessible configuration file includes user-set preferences for the at least one operating parameter.
(9) The networking device of one or more of (1) to (8), wherein the user-set preferences comprise one or more of a preference to optimize core count of the one or more processing resources, a preference to optimize clock frequency of the one or more processing resources, a preference to optimize available memory capacity of the one or more memory resources, or a preference to optimize bandwidth of the one or more memory resources.
(10) The networking device of one or more of (1) to (9), wherein the at least one user-accessible configuration file includes a plurality of predefined options for the at least one operating parameter.
(11) The networking device of one or more of (1) to (10), wherein the one or more processing resources provide feedback to a user through a user interface to confirm successful configuration of the networking device according to the at least one user-accessible configuration file.
(12) A DPU, comprising:
   a processor core subsystem including one or more processor cores;
   a network interface controller (NIC) subsystem;
   an interface that facilitates communication between the processor core subsystem and the NIC subsystem; and
   at least one memory that stores at least one user-accessible configuration file comprising a system budget that controls at least one operating parameter of the DPU, wherein the system budget includes at least one of a power consumption limit for the DPU and a thermal limit for the DPU.
(13) The DPU of (12), wherein the at least one operating parameter is selected to avoid exceeding either the power consumption limit or the thermal limit.
(14) The DPU of one or more of (12) to (13), wherein the at least one operating parameter comprises a number of active processing resources in the one or more processing resources, a clock frequency of the active processing resources, an amount of memory usage of the at least one memory, operating voltage of the active processing resources, operating voltage of the at least one memory, operating temperature of the active processing resources, or any combination thereof.
(15) The DPU of one or more of (12) to (14), wherein access to the at least one user-accessible configuration file is controlled and limited.
(16) The DPU of one or more of (12) to (15), wherein the at least one user-accessible configuration file includes user-set preferences for the at least one operating parameter including one or more of a preference to maximize core count of the one or more processing resources, a preference to maximize clock frequency of the one or more processing resources, a preference to maximize available memory capacity of the at least one memory, or a preference to maximize bandwidth of the at least one memory.
(17) The DPU of one or more of (12) to (16), wherein the at least one user-accessible configuration file includes a plurality of predefined options for the at least one operating parameter.
(18) The DPU of one or more of (12) to (17), wherein the processor core subsystem reads the at least one user-accessible configuration file from the at least one memory and forwards the at least one user-accessible configuration file to the NIC subsystem over the interface.
(19) A networking device, comprising:
   one or more memory resources to store at least one user-accessible configuration file comprising a system budget for the networking device, wherein the system budget includes at least one of a power consumption limit for the networking device and a thermal limit for the networking device; and
   one or more processing resources to read the at least one user-accessible configuration file and to provide a user, through a user interface, with options to select at least one operating parameter of the networking device that keeps the networking device within the system budget.
(20) The networking device of (19), wherein the at least one operating parameter comprises a number of active processing resources in the one or more processing resources, a clock frequency of the one or more processing resources, an amount of memory usage of the one or more memory resources, operating voltage of a processing resource in the one or more processing resources, operating voltage of a memory resource in the one or more memory resources, temperature of a processing resource in the one or more processing resources, or any combination thereof.

What is claimed is:

1. A networking device, comprising:
one or more processing resources to perform networking functions; and
one or more memory resources to store at least one user-accessible configuration file comprising a system budget that controls at least one operating parameter of the networking device, wherein the system budget includes at least one of a power consumption limit for the networking device and a thermal limit for the networking device.

2. The networking device of claim 1, wherein the one or more processing resources comprise resources of a data processing unit (DPU).

3. The networking device of claim 1, wherein the at least one operating parameter comprises a number of active processing resources in the one or more processing resources, a clock frequency of the one or more processing resources, an amount of memory usage of the one or more memory resources, operating voltage of a processing resource in the one or more processing resources, operating voltage of a memory resource in the one or more memory resources, operating temperature of a processing resource in the one or more processing resources, or any combination thereof.

4. The networking device of claim 1, further comprising:
an interface that facilitates communication, wherein the one or more processing resources comprises a processor core subsystem and a network interface controller (NIC) subsystem coupled to one another through the interface.

5. The networking device of claim 1, wherein, upon power-up of the networking device, the one or more processing resources:
reads the at least one user-accessible configuration file from the one or more memory resources; and
sets, based on user input received through a user interface, the at least one operating parameter.

6. The networking device of claim 1, wherein access to the at least one user-accessible configuration file is controlled and limited.

7. The networking device of claim 1, wherein the at least one operating parameter is selected to avoid exceeding either the power consumption limit or the thermal limit.

8. The networking device of claim 1, wherein the at least one user-accessible configuration file includes user-set preferences for the at least one operating parameter.

9. The networking device of claim 8, wherein the user-set preferences comprise one or more of a preference to optimize core count of the one or more processing resources, a preference to optimize clock frequency of the one or more processing resources, a preference to optimize available memory capacity of the one or more memory resources, or a preference to optimize bandwidth of the one or more memory resources.

10. The networking device of claim 1, wherein the at least one user-accessible configuration file includes a plurality of predefined options for the at least one operating parameter.

11. The networking device of claim 1, wherein the one or more processing resources provide feedback to a user through a user interface to confirm successful configuration of the networking device according to the at least one user-accessible configuration file.

12. A DPU, comprising:
a processor core subsystem including one or more processor cores;
a network interface controller (NIC) subsystem;
an interface that facilitates communication between the processor core subsystem and the NIC subsystem; and
at least one memory that stores at least one user-accessible configuration file comprising a system budget that controls at least one operating parameter of the DPU, wherein the system budget includes at least one of a power consumption limit for the DPU and a thermal limit for the DPU.

13. The DPU of claim 12, wherein the at least one operating parameter is selected to avoid exceeding either the power consumption limit or the thermal limit.

14. The DPU of claim 13, wherein the at least one operating parameter comprises a number of active processing resources in the processor core subsystem and the NIC subsystem, a clock frequency of the active processing resources, an amount of memory usage of the at least one memory, operating voltage of the active processing resources, operating voltage of the at least one memory, operating temperature of the active processing resources, or any combination thereof.

15. The DPU of claim 12, wherein access to the at least one user-accessible configuration file is controlled and limited.

16. The DPU of claim 12, wherein the at least one user-accessible configuration file includes user-set preferences for the at least one operating parameter including one or more of a preference to maximize core count of the one or more processor cores, a preference to maximize clock frequency of the one or more processor cores, a preference to maximize available memory capacity of the at least one memory, or a preference to maximize bandwidth of the at least one memory.

17. The DPU of claim 12, wherein the at least one user-accessible configuration file includes a plurality of predefined options for the at least one operating parameter.

18. The DPU of claim 12, wherein the processor core subsystem reads the at least one user-accessible configuration file from the at least one memory and forwards the at least one user-accessible configuration file to the NIC subsystem over the interface.

19. A networking device, comprising:
one or more memory resources to store at least one user-accessible configuration file comprising a system budget for the networking device, wherein the system budget includes at least one of a power consumption limit for the networking device and a thermal limit for the networking device; and
one or more processing resources to read the at least one user-accessible configuration file and to provide a user, through a user interface, with options to select at least one operating parameter of the networking device that keeps the networking device within the system budget.

20. The networking device of claim 19, wherein the at least one operating parameter comprises a number of active processing resources in the one or more processing resources, a clock frequency of the one or more processing resources, an amount of memory usage of the one or more memory resources, operating voltage of a processing resource in the one or more processing resources, operating voltage of a memory resource in the one or more memory resources, temperature of a processing resource in the one or more processing resources, or any combination thereof.
